(19) United States
(12) Patent Application Publication
(10) Pub. No.: US 2005/0247273 A1
(43) Pub. Date: Nov. 10, 2005

(54) Pneumatic spring for starting a free piston internal combustion engine

(76) Inventor: Cliff Carlson, Fenton, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 10/840,962

(22) Filed: May 7, 2004

(51) Int. Cl. F02B 71/00

(52) U.S. Cl. 123/46 R

(57) ABSTRACT

A method according to this invention for starting a free piston internal combustion engine having no crankshaft for controlling movement of the piston, includes providing a combustion cylinder, a piston moveable in the cylinder, and an inlet port opened and closed by the piston as the piston moves in the cylinder, through which inlet port air enters the cylinder. The piston is displaced linearly in the cylinder sufficiently to open the inlet port before admitting fuel to the cylinder to start the engine.

### BACKGROUND OF THE INVENTION

The invention relates to starting an internal combustion engine. In particular, the invention pertains to providing a pneumatic charge in the combustion cylinders for use in starting a compression ignition or spark ignition free piston engine.

A free piston internal combustion engine includes one or more reciprocating pistons located in a combustion cylinder and connected to a load. A crankshaft does not mutually connect the pistons. Instead, during operation, each piston reciprocates in response to forces produced by combustion of an air-fuel mixture in a combustion chamber or cylinder without a crankshaft drive connection to another piston. Piston displacement and piston velocity are monitored and controlled by an actuator system employed to correct periodically minor deviations from synchronized piston movement. The actuator system may be used also to reciprocate the piston while starting the engine before combustion of an air-fuel mixture occurs in the cylinder.

The engine may drive a current carrying conductor in a magnetic field, thereby inducing an electrical current in the conductor and producing electrical power output. Alternatively, the pistons may be driveably connected to a hydraulic or pneumatic pump-motor, which supplies pressurized fluid to a motor that drives a load, e.g., the wheels of a motor vehicle. A free piston engine that produces hydraulic output includes a hydraulic cylinder and a plunger, driven by the engine, for pumping hydraulic fluid from a fluid source to a high pressure fluid accumulator.

A free piston engine may include only one piston in a combustion cylinder. In such an engine, after combustion occurs the piston is driven away from the cylinder head by the expansion of the fuel-air charge between the piston and head, but an external power source is required to move the piston toward the cylinder head to compress the next fuel-air charge during the compression stroke. Preferably electric energy is used to drive the piston during the compression stroke when the engine produces electric output, and hydraulic or pneumatic energy is used to drive the piston during the compression stroke when the engine produces hydraulic or pneumatic output.

An alternate arrangement of a free piston engine may include axially-aligned cylinders, an axially inner pair of mutually connected pistons, and an axially outer pair of mutually connected pistons. One piston of each piston pair reciprocates in a first engine cylinder; the other piston of each pair reciprocates in a second cylinder. Each cylinder is formed with inlet ports, through which air enters the cylinder, exhaust ports, through which exhaust gas leaves the cylinder, and a fuel port, through which fuel is injected into the cylinder. Movement of the pistons in one cylinder caused by combustion of a fuel-air mixture there, forces the pistons in the other cylinder to compress subsequently a fuel-air mixture in the second cylinder and to cause combustion of that mixture. In this way the piston pairs reciprocate in the cylinders in mutual opposition, one piston pair moving longitudinal in one direction while the pistons of the other pair move in the opposite direction to compress the mixture is one cylinder. When combustion occurs there, the direction of movement of each piston pair is reversed until the combustion occurs in the other cylinder.

Because a free piston engine has no shaft connecting the pistons for synchronizing their reciprocation in the cylinders and connecting the pistons to the load, motion of the pistons is controlled by a control system that synchronizes coordinated piston reciprocation, compression and combustion of an air-fuel mixture. While starting a free piston engine, however, the engine pistons must be actuated to produce combustion to a sufficient compression ratio, which depends, at least in part, on the extent to which the pistons move in the cylinder and the temperature of the air-fuel charge in the cylinder. Piston movement during engine starting may be actuation hydraulically, pneumatically or electrically.

Various techniques have been devised for starting a compression ignition engine. For example, hydraulic or pneumatic motor-pumps, driveably connected to the engine pistons, may be used to reciprocate the pistons while starting the engine under the control of servo-hydraulic valves. These valves are fast acting and provide a high fluid flow rate, but they are expensive and have limited long-term prospects for cost reduction.

When an engine is stopped, the piston can be at any position in the cylinder. A free piston engine typically has no inlet valves or exhaust valves to control the flow of air and exhaust gas into and from the cylinder. Instead, the inlet is usually pressurized by a turbocharger, and reed valves are opened by fluid entering the cylinder. If the engine is stopped with a piston in the compression stroke, leakage of the air charge from the cylinder through the inlet and exhaust ports and across the piston rings will occur during the shutdown period due to the pressure in the cylinder. This leakage produces a partial vacuum in the cylinder. A free piston engine, however, relies on a compressible charge in the cylinder to provide a pressure force on the piston head resisting the force that moves the piston to the TDC position during the compression stroke. A technique is required to avoid these and related difficulties that arise when starting a free piston engine.

### SUMMARY OF THE INVENTION

An engine to which this invention can be applied includes first and second pairs of mutually connected pistons, a first piston of each pair moving in a first cylinder, and a second piston of each pair moving in a second cylinder. Each cylinder has inlet ports and exhaust ports through which fresh air and exhaust gas enter and leave the cylinders, respectively.

A method according to this invention for starting a free piston internal combustion engine having no crankshaft for controlling movement of the piston, includes providing a combustion cylinder, a piston moveable in the cylinder, and an inlet port opened and closed by the piston as the piston moves in the cylinder, through which inlet port air enters the cylinder. The piston is displaced linearly in the cylinder sufficiently to open the inlet port before admitting fuel to the cylinder to start the engine.

The method for starting a free piston internal combustion engine having no crankshaft for controlling movement of the piston can be applied also to such an engine that includes axially aligned combustion cylinders, a first pair of mutually connected pistons, and a second pair of mutually connected pistons. A first piston of each pair is moveable in the first cylinder. A second piston of each pair is moveable in the second cylinder. Each cylinder includes an inlet port, through which air enters the cylinder, movement of the pistons closing and opening the inlet ports. The pistons in the first cylinder are moved sufficiently to open the inlet port of the first cylinder before admitting fuel to the first cylinder to start the engine. The pistons in the second cylinder are moved sufficiently to open the inlet port of the second cylinder before admitting fuel to the second cylinder to start the engine.

Various objects and advantages of this invention will become apparent to those skilled in the art from the following detailed description of the preferred embodiment, when read in light of the accompanying drawings.

### BRIEF DESCRIPTION OF THE DRAWINGS

FIGS. 1 and 2 are cross sectional views taken at a longitudinal plane through a free piston engine showing schematically the position of piston pairs and combustion cylinders at opposite ends of their displacement;

FIG. 3 is a schematic diagram of a fluid control system having a controller for operating fluid pump-motors connected to the engine piston pairs for starting the engine; and

FIG. 4 is a cross sectional schematic diagram of a free piston engine having a single piston reciprocating in each cylinder and an actuator for starting the engine.

### DETAILED DESCRIPTION OF THE PREFERRED EMBODIMENT

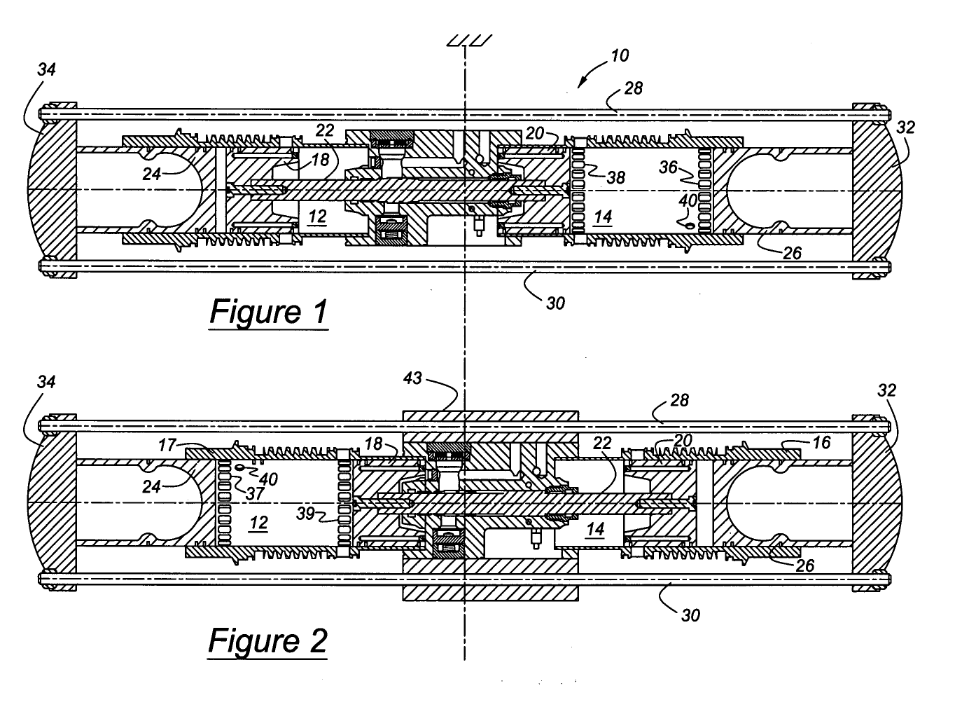

Referring first to FIGS. 1 and 2, a free piston engine 10 includes a first cylinder 12 and a second cylinder 14, axially aligned with the first cylinder, the cylinders being located in cylinder liners or engine blocks 16, 17. A first pair of pistons, inner pistons 18, 20, are mutually connected by a push rod 22. A first piston 18 of the first piston pair reciprocates within the first cylinder 12, and the second piston 20 of the first piston pair reciprocates within the second cylinder 14. A second pair of pistons, outer piston 22, 24, are connected mutually by pull rods 28, 30, secured mutually at the axial ends of pistons 24, 26 by bridges 32, 34. A first piston of the second or outer piston pair reciprocates within the first cylinder 12, and a second piston 26 of the outer piston pair reciprocates within the first cylinder 14. Each cylinder 12, 14 is formed with air inlet ports 36, 37 and exhaust ports 38, 39. In FIG. 1, the ports 37, 39 of cylinder 12 are closed by pistons 18, 24, which are located near their top dead center (TDC) position, and the ports 36, 38 of cylinder 14 are opened by pistons 18, 24, which are located near their bottom center (BDC) position. In FIG. 2, ports 36, 38 of cylinder 14 are closed by pistons 20, 26, which are located near their TDC position, and the ports 37, 39 of cylinder 12 are opened by pistons 18, 24, which are located near their BDC position. When the pistons of either cylinder are at the TDC position, the pistons of the other cylinder are at or near their BDC position. Each cylinder is formed with a fuel port 40, through which fuel is admitted, preferably by injection, into the cylinder during the compression stroke.

Displacement of the piston pairs between their respective TDC and BDC positions, the extremities of travel shown in FIGS. 1 and 2, is coordinated such that a fuel-air mixture located in the space between pistons 18, 24 in cylinder 12 and between pistons 20, 26 in cylinder 14 is compressed so that combustion of those mixtures occurs within the cylinders when the pistons have moved slightly past the TDC position toward the BDC position. This synchronized reciprocation of the piston pairs is referred to as “opposed piston-opposed cylinder” (OPOC) reciprocation.

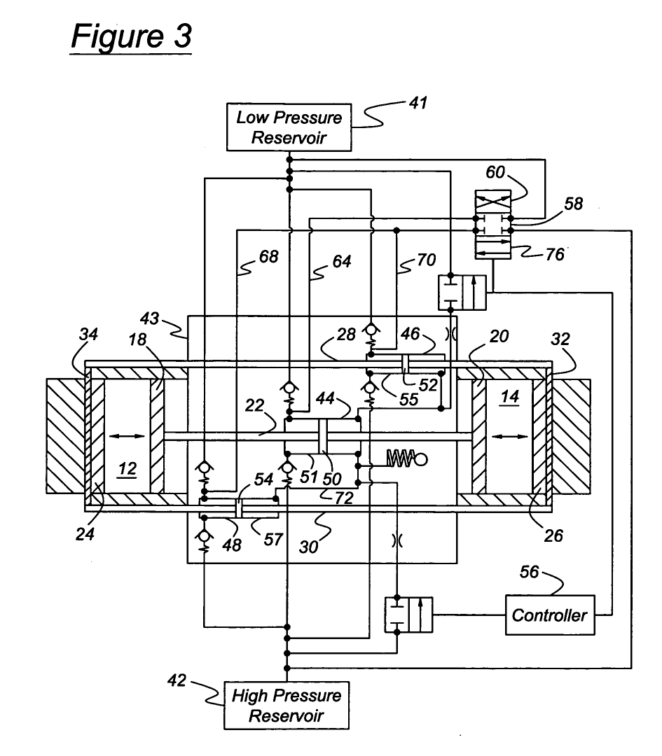

The synchronized, coordinated movement of the pistons is controlled through a hydraulic circuit, that includes fluid motor-pumps check valves and lines contained in a hydraulic or pneumatic block 43, located axially between the cylinder sleeves 16, 17. Referring next to FIG. 3, the control circuit includes a low pressure accumulator 41, a high pressure accumulator 42, a motor pump 44 driveably connected to push rod 22, a motor pump 46 driveably connected to pull rod 28, and a motor pump 48 driveably connected to pull rod 30. Push rod 22 is formed with a piston 50 located in a cylinder 51 formed in block 43. Reciprocation of engine pistons 18, 20 causes piston 50 of motor pump 44 to reciprocate. Pull rods 28, 30 are each formed with pistons 52, 54, located in cylinders 55, 57, respectively, formed in block 43. Reciprocation of engine pistons 24, 26 causes pistons 52, 54 of motor pumps 46, 48 to reciprocate.

When the engine 10 is running, the coordinated reciprocating movement of the engine pistons draws fluid from the low pressure accumulator 41 to the pump motors 44, 46, 48, which produce hydraulic or pneumatic output fluid flow, supplied to the high pressure accumulator 42. The motor-pumps 44, 46, 48 operate as motors driven by pressurized fluid in order to start the engine, and operate as pumps to supply fluid to the high pressure accumulator for temporary storage there or to supply fluid directly to fluid motors located at the vehicle wheels, which drive the wheels in rotation against a load.

An electronic controller 56 produces an actuating signal transmitted to a solenoid or a relay, which, in response to the actuating signal, changes the state of a control valve 58. For example, when the hydraulic system is operating as a motor to move the engine pistons preparatory to starting the engine or while the engine is being started, controller 56 switches valve 58 between a first state 60, at which accumulator 42 is connected through valve 58 to the left-hand side of the cylinder 51 of pump-motor 44 through line 64. With valve 58 in the state 60, the left-hand sides of the cylinders 55, 57 of motor-pumps 46, 48, are connected through lines 68, 70 and valve 58 to the low pressure accumulator 41. These actions cause piston 50 to move rightward forcing fluid from pump-motor 44 through line 72 to the right-hand side of the cylinder 57, and through line 74 to the right-hand side of cylinder 55. In this way, the first state of valve 58 causes the fluid control system to move engine pistons 18, 20 rightward and engine pistons 24, 26 to move leftward from the position shown in FIG. 3.

When controller 56 switches valve 58 to the second state 76, high pressure accumulator 42 is connected through line 68 to the left-hand side of piston 57 of motor-pump 48, and through line 70 to the left-hand side of piston 55 of motor-pump 46. This forces engine pistons 24, 26 rightward. When valve 58 is in the second state 76, the low pressure accumulator 41 is connected through valve 58 and line 64 to the left-hand side of cylinder 51 of motor-pump 44. As pistons 52, 54 move rightward, fluid is pumped from cylinders 55, 57 through lines 74, 72, respectively, to the right-hand side of cylinder 51. This causes piston 50, push rod 22 and engine pistons 18, 20 to move leftward.

To start the engine 10, before fuel is injected, pistons 18, 20 are moved leftward and pistons 24, 26 are moved rightward by the actuator system, described with reference to FIG. 3, toward the position shown in FIG. 1. This causes the pistons to open the inlet ports 36 in cylinder 14, thereby ensuring that cylinder 14 is filled with a pneumatic charge. Next, pistons 18, 20 are moved rightward and pistons 24, 26 are moved leftward by the actuator system toward the position shown in FIG. 2. This causes the pistons to open the inlet ports 37 in cylinder 12, thereby ensuring that cylinder 12 is filled with a pneumatic charge. Then, the actuation system reciprocates the pistons with continually increasing displacement, or length of stroke, in each cycle. The increase of piston displacement is accomplished by progressively increasing the magnitude of the pressure applied to actuator during each displacement cycle, or by increasing the length of the period when pressure is applied to the actuator, or by a combination of these actions. In any case, cyclic compression and expansion of the pneumatic charges in cylinder 12, 14 are analogous to that of springs, opposing acceleration of the piston masses toward each TDC position. The actuation system provides a force that accelerates the pistons toward each TDC position.

Pistons 18, 24 move rapidly in cylinder 12 due to combustion in cylinder 14. An engine controller causes a fuel injector to inject an appropriate quantity of fuel into cylinder 12 between pistons 18, 24 through fuel port 40, thereby starting the engine start. The engine continues to run under programmed control with fuel injection being actively controlled by the engine controller.

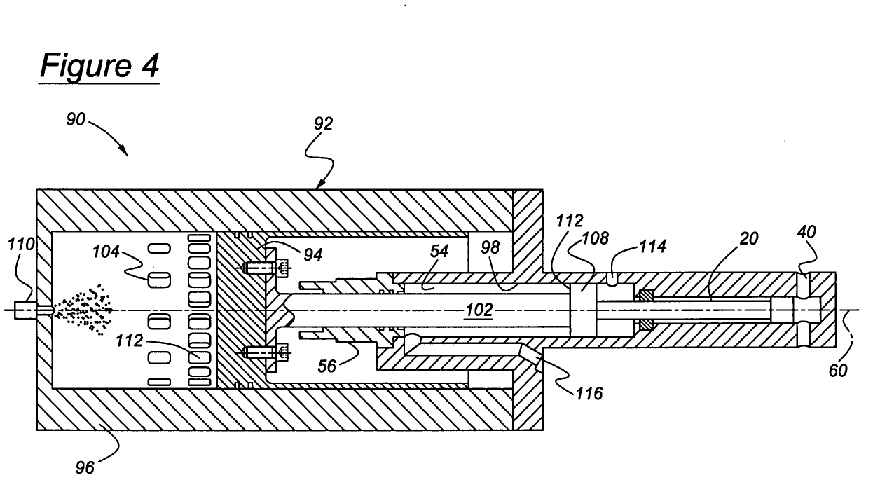

FIG. 4 shows a free piston engine 90 that includes a housing 92, a piston 94 reciprocating in a combustion cylinder 96, a compression cylinder 98 and a load 100 secured by a shaft 102 to the piston. Air enters the cylinder through air inlet ports 102, and exhaust gas leaves the cylinder through exhaust ports 104. Air is carried through inlet ports 102 into combustion chamber 106 when piston 90 nears its BDC position. As piston 90 moves toward its TDC position, fuel is injected into combustion chamber 106 by a fuel injector operating under control of a fuel control system 110.

Piston 94 is supported for reciprocal linear displacement in the combustion chamber 106. An engine starting system for actuating the piston includes an actuator piston head 108 attached to shaft 102 located in cylinder 98 for movement with the piston 94. Fluid ports 114 and 116 carry pressurized fluid into cylinder 98 from opposite sides of piston head 108. A pressure force, produced by pressurized fluid in cylinder 98, causes piston head 108 and piston 94 to move toward the TDC position during the compression stroke. Pressurized fluid entering cylinder 98 through fluid port 116 causes piston head 108 and piston 94 to move toward the BDC position while the engine is being started or if the engine should misfire.

To start the engine 90, after an ignition switch is turned ON and before fuel is injected, piston 94 is moved by the actuator system toward the BDC position sufficiently to open the inlet ports 102, thereby ensuring that chamber 106 is filled with a pneumatic charge. Then, the actuation system causes piston 94 to reciprocate in chamber 106 with continually increasing displacement amplitude in each displacement cycle. The increase of piston displacement is accomplished by progressively increasing the magnitude of the pressure applied to actuator head 108 during each displacement cycle, or by increasing the length of the period when pressure is applied to head 108, or by applying pressure alternately to both sides of head 108, or by a combination of these actions. In any case, cyclic compression and expansion of the pneumatic charge is analogous to that of spring, opposing acceleration of the piston mass toward the TDC position. The actuation system provides a force that accelerates the piston toward the TDC position.

After the piston head 110 reaches a predetermined position in the combustion chamber during this reciprocation cycling procedure, or when a predetermined compression ratio in chamber 106 is reached, or when pressure in compression chamber 106 reaches a predetermined magnitude, fuel is injected into chamber 106 in a suitable volume to produce combustion and to start the engine 90.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method for starting a free piston internal combustion engine having no crankshaft for controlling movement of the piston, the method comprising the steps of:
providing a combustion cylinder, a piston moveable in the cylinder, an inlet port opened and closed by the piston as the piston moves in the cylinder, through which inlet port air enters the cylinder; and
moving the piston in the cylinder sufficiently to open the inlet port before admitting fuel to the cylinder to start the engine.

2. The method of claim 1, further comprising:
providing an exhaust port through which exhaust gas leaves the cylinder, movement of the piston in the cylinder opening and closing the exhaust port; and
moving the piston in the cylinder sufficiently to close the exhaust port before admitting fuel to the cylinder to start the engine.

3. The method of claim 1, further comprising:
providing an actuator for displacing the piston in the cylinder;
using the actuator to move the piston in the cylinder sufficiently to open the inlet port before admitting fuel to the cylinder.

4. The method of claim 1, further comprising:
providing an actuator for displacing the piston in the cylinder;
providing an exhaust port through which exhaust gas leaves the cylinder, movement of the piston in the cylinder opening and closing the exhaust port;
using the actuator to move the piston in the cylinder sufficiently to open the inlet port before admitting fuel to the to start the engine; and
using the actuator to move the piston in the cylinder sufficiently to close the exhaust port before admitting fuel to the cylinder to start the engine.

5. A method for starting a free piston internal combustion engine having no crankshaft for controlling movement of the piston, the method comprising the steps of:
providing a combustion cylinder having a head that seals an end of the cylinder against passage of fluid, an air inlet port through which air enters the cylinder, a piston moveable along a portion of a length of the cylinder between the cylinder head and inlet port, movement of the piston opening and closing the inlet port;
moving the piston in the cylinder sufficiently to open the inlet port; and
moving the piston in the cylinder to close the inlet port and retain a charge of air in the cylinder between the cylinder head and the piston.

6. A method for starting a free piston internal combustion engine having no crankshaft for controlling movement of the piston, the method comprising the steps of:
providing axially aligned combustion cylinders, a first pair of mutually connected pistons, a second pair of mutually connected pistons, a first piston of each pair moveable in the first cylinder, a second piston of each pair moveable in the second cylinder, each cylinder having an inlet port through which air enters the cylinder, movement of the pistons closing and opening the inlet ports;
moving the pistons in the first cylinder sufficiently to open the inlet port of the first cylinder before admitting fuel to the first cylinder to start the engine; and
moving the pistons in the second cylinder sufficiently to open the inlet port of the second cylinder before admitting fuel to the second cylinder to start the engine.

7. The method of claim 6, further comprising:
providing an exhaust port in each cylinder, through which exhaust port exhaust gas leaves the corresponding cylinder, movement of the pistons opening and closing the exhaust ports;
moving the pistons in the first cylinder sufficiently to close the exhaust port of the first cylinder before admitting fuel to the first cylinder to start the engine; and
moving the pistons in the second cylinder sufficiently to close the exhaust port of the second cylinder before admitting fuel to the second cylinder to start the engine.

8. The method of 6, further comprising:
providing an actuator for displacing the pistons in the cylinders; and wherein the steps of moving the pistons further comprise:
using the actuator to move the pistons in the first cylinder sufficiently to open the inlet port of the first cylinder; and
using the actuator to move the pistons in the second cylinder sufficiently to open the inlet port of the second cylinder.

9. The method of claim 6, further comprising:
providing an actuator for displacing the pistons in the cylinder;
providing an exhaust port in each cylinder, through which exhaust port exhaust gas leaves the corresponding cylinder, movement of the pistons opening and closing the exhaust ports; and wherein the steps of moving the pistons further comprise:
using the actuator to move the pistons in the first cylinder sufficiently to open the inlet port of the first cylinder before admitting fuel to the second to start the engine;
using the actuator to move the pistons in the second cylinder sufficiently to open the inlet port of the second cylinder before admitting fuel to the second to start the engine;
using the actuator to move the pistons in the first cylinder sufficiently to close the exhaust port of the first cylinder; and
using the actuator to move the pistons in the second cylinder sufficiently to close the exhaust port of the second cylinder.
